(19) United States
(12) Patent Application Publication
(10) Pub. No.: US 2025/0106542 A1
(43) Pub. Date: Mar. 27, 2025

(54) HOLDING DEVICE FOR A WIND SHIELD AND A MICROPHONE

(71) Applicant: DPA Microphones A/S, Kokkedal (DK)

(72) Inventors: Timo Klinge, Hamburg (DE); Federic Sonnenberg, Freiburg im Breisgau (DE)

(21) Appl. No.: 18/887,614

(22) Filed: Sep. 17, 2024

(30) Foreign Application Priority Data
Sep. 21, 2023 (EP) 23198734.8
Sep. 16, 2024 (EP) 24200454.7

(51) Int. Cl. H04R 1/08

(52) U.S. Cl. CPC H04R 1/086; H04R 2410/07

(57) ABSTRACT

Disclosed herein is a holding device for a wind shield and a microphone, the holding device having an opening for insertion and/or retraction of the microphone in the holding device; a clamping mechanism for fixating on the microphone; a supporting portion for supporting a material of the wind shield; a stopping element for arranging the microphone in a desired position in the holding device; and a boundary surface, which may be configured for acoustically amplifying a specific frequency range of a sound signal impinging on the microphone.

### CROSS REFERENCE TO RELATED APPLICATIONS

This application claims the benefit of priority to European Patent Application No. 23198734.8, filed on Sep. 21, 2023 and European Patent Application No. 24200454.7, filed on Sep. 16, 2024. The disclosures of the above-referenced applications are hereby expressly incorporated by reference in their entireties.

### FIELD

The present invention relates to a holding device for a wind shield and a microphone. More specifically, the disclosure relates to a holding device comprising an opening for insertion and/or retraction of the microphone in the holding device. The holding device comprises a clamping mechanism for fixating on the microphone. The holding device comprises a supporting portion for supporting a material of the wind shield.

### BACKGROUND

In prior art, state of the art existing lavalier wind shields is to use a variety of different products for the different microphone diameters. The microphones are pushed into the wind shield protection from the back without any indication of the position of the microphone inside the closed volume. This results in misplaced microphones, which results in bad wind rejection efficiency, and additional noise created by the microphone hitting/rubbing again the inside of the wind shield material.

Thus, there is a need for an improved solution for wind shields for microphones, such as lavalier microphones.

### SUMMARY

Disclosed is a holding device for a wind shield and a microphone. The holding device comprises an opening for insertion and/or retraction of the microphone in the holding device. The holding device comprises a clamping mechanism for fixating on the microphone. The holding device comprises a supporting portion for supporting a material of the wind shield. The holding device comprises a stopping element for arranging the microphone in a desired position in the holding device. The holding device comprises a boundary surface. The boundary surface may be for acoustically amplifying a specific frequency range of a sound signal impinging on the microphone.

The holding device is for a wind shield and a microphone. Thus, the holding device is configured for holding a microphone. The holding device is configured for holding a wind shield, where the wind shield is configured for shielding or protecting the microphone from wind, blow, breathing sounds of a person and other undesired sounds, air pressures etc. The holding device functions as a mount for the microphone, e.g. the microphone capsule. The holding device may be manufactured from rigid, or semi-rigid components, such as plastics, silicone etc. The holding device is configured for holding a wind shield and a microphone, thus the features of the holding device which are described in the present application, are not configured for attaching to e.g. clothes of a user. If attachment to e.g. clothes of a user is relevant, then such an attachment means may be arranged on the housing or cord of microphone, see e.g. FIG. 2.

The wind shield material may be faux fur, a fabric, a cloth, a textile etc.

The microphone may be a microphone capsule. The microphone may be or comprise a housing for a microphone. The microphone may be an input transducer for capturing sounds e.g. from a user of the holding device. The microphone may comprise a cord/cable/wire configured to be connected with an electronic device, such as for transmission of the sound captured by the microphone. The microphone may a microphone for a headset, such as a microphone on a boom. The microphone may be a lavalier microphone. A lavalier microphone also called a lavalier, a lav, lapel mic, clip mic, body mic, collar mic, neck mic or personal mic, is a small microphone which may be used for television, theater, and public speaking applications to allow hands-free operation. Lavalier microphones may be provided with small clips for attaching to collars, ties, or other clothing. The microphone cord may be hidden by clothes and either run to a radio frequency transmitter kept in a pocket or clipped to a belt, or routed directly to the mixer or a recording device.

The holding device comprises an opening for insertion and/or retraction of the microphone in the holding device. The opening may be arranged in a center of the holding device. The opening may have a dimension which allows the microphone to fit in the opening. The opening is for insertion of the microphone when the holding device is being prepared to use by a user. The opening is also for retraction of the microphone out of the holding device, such as after the holding device has been used by the user, or if a part should be replaced etc.

The holding device comprises a clamping mechanism for fixating on the microphone. The clamping mechanism is for fixating the microphone, holding the microphone in place, maintaining the microphone in a fixed, steady position in the holding device. The clamping mechanism is configured to clamp the microphone, such that when the microphone has been inserted through the opening, the clamping mechanism ensures that the microphone stays in the holding device.

The holding device comprises a supporting portion for supporting a material of the wind shield. The supporting portion may comprise one or more elements, such as arches. The supporting portion may support, space out, hold, spread out, lift, and/or maintain the material of the wind shield. The material of the wind shield may not be attached or fixed to the supporting portion, but rather the material of the wind shield may rest on the supporting portion. The supporting portion is configured to support the material of the wind shield to provide a space underneath the material of the wind shield. The material of the wind shield may be attached at or under the clamping mechanism, such as at or under a boundary surface of the holding device.

The holding device comprises a stopping element for arranging the microphone in a desired position in the holding device. The stopping element may comprise one or more elements, such as elements with a dimension suitable for matching the microphone. The stopping element is for ensuring that the microphone is not pushed too far/high up in the holding device. The stopping element is configured to work as a guide to the user, such that the user is guided/directed as to how far to push the microphone through the opening. The stopping element is configured to ensure that the user pushes the microphone up until the stopping element and also ensuring that the user does not push the microphone too little in the device. If the microphone is pushed too far into the holding device, the microphone may be too close to the wind shield, and the sound quality may not be optimal. If the microphone is pushed too little into the holding device, the microphone may be too far from the mouth of the user or from the wind shield, and the sound quality may not be optimal.

The holding device comprises a boundary surface. The boundary surface may be for acoustically amplifying a specific frequency range of a sound signal impinging on the microphone. The boundary surface may be a top surface of at least a part of the clamping mechanism. The boundary surface may extend around the opening of the holding device. The boundary surface may extend in a plane which is perpendicular to an insertion direction of the microphone in the holding device. The specific frequency range may be about 8 kHz and higher, such as about 9 kHz and higher, such as about 10 kHz and higher.

It is an advantage that the boundary surface is designed in a way that may only reinforce a certain frequency range of the sound. Frequencies with wave lengths long enough to bend around the boundary surface may not be affected by the design. Frequencies with a wavelength small enough to be reflected by the boundary surface may be in-phase reinforced and may show an increased level of sound intensity, sound volume, sound power, sound pressure up to +6 dB. Thus, modifying the boundary surface diameter may also modifie the frequency range of the pressure zone. The pressure zone or pressure field may be defined as the area, space where sound waves build up and are compressed. The pressure zone, pressure field may be generated by the boundary surface right behind the microphone. The boundary surface may have any given shape. However, circular shapes may provide the best size/performance coefficient, and may create the most harmonic frequency range amplification.

It is an advantage of the boundary surface that the wind protection, of the holding device with the wind shield material attached, can be adjusted to only compensate for the respective frequency loss of any given faux fur.

The microphone, e.g. the microphone capsule, may be positioned anywhere inside the pressure zone, pressure field. However, for the intended application of the holding device it may be advantageous to locate the microphone in the centre of the boundary surface to achieve a symmetrical polar response. If the microphone is located outside the symmetrical centre of the surface, reflections and phase correlations may cause a change of the frequency response depending on the direction of arrival of the sound. Therefore, the microphone may change in sound with its orientation to the sound source. However, the position may be adjusted for other applications.

Furthermore, the orientation of the microphone, e.g. the microphone capsule, to the boundary surface may be irrelevant to the functionality if the diaphragm is situated inside the pressure zone.

The in-phase reinforcement of the frequency range may only take place at a short distance above the boundary surface. The higher the frequency gets, the smaller the distance to the boundary surface must be.

Therefore it is an advantage that the mechanical design of the holding device incorporates the stopping element that physically stop the microphone in the ideal spot inside the pressure zone. The stopping element design is compatible with a range of different microphones, and microphone diameters.

In prior art, state of the art existing lavalier wind shields is to use a variety of different products for the different microphone diameters. The microphones are pushed into the wind shield protection from the back without any indication of the position of the microphone inside the closed volume. This results in misplaced microphones, which results in bad wind rejection efficiency, and additional noise created by the microphone hitting/rubbing again the inside of the wind shield material.

In prior art, all current wind protections for higher wind speeds are utilizing faux fur as first layer of wind absorption. State of the art on existing lavalier wind shields is to use faux fur to absorb the kinetic energy of the air flow, while allowing the acoustic energy to pass through. This technology has proven to be very efficient and can be modified by the fur choice to the requirements of the protection. However, the fur is also having an impact on the acoustics of the wind protection. Depending on fur density, stiffness, length, and age, frequencies of about 8 kHz, or about 9 kHz, or about 10 kHz and higher will get attenuated and so the sound of the microphone will be directly affected.

It is an advantage of the present holding device design, and of the resulting wind protection when microphone and wind shield material is arranged on the holding device, that it compensates for this high frequency loss of the faux fur by acoustically amplifying higher frequencies with a pressure zone inside the wind shield material on the holding device.

It is an advantage of the holding device that is comprises the clamping mechanism which is configured for fixating on the microphone to hold the microphone in place in the holding device.

In prior art, the current state of the art of closing the microphone on the microphone body is to use sewn-in rubber bands, or rubber grommets. This results in a trade-off between rigidity of the mount versus compatibility with different microphone diameters.

Thus, it is an advantage of the clamping mechanism that it provides for an improved solution of holding the microphone compared to prior art.

In conclusion, it is an advantage of the invention that by adding a boundary surface behind the microphone, e.g. the microphone capsule, the holding device provides, when in use with wind shield material and microphone, boosting of frequencies which are attenuated by the faux fur, and therefore compensates the frequency loss of the wind protection.

It is an advantage of the holding device that it allows the user to utilize the same holding device, e.g. wind shield product, for all or most of the used broadcast lavalier microphones. Furthermore, the holding device provides to position the microphone in the perfect spot inside the holding device, e.g. inside the wind protection, to provide the best possible wind protection efficiency inside the given volume.

It is an advantage of the holding device that it comprises the opening and the clamping mechanism to provide a functionality of an opening microphone mount on lavalier wind protection.

It is an advantage of the holding device that it comprises the stopping element to is provide a physical stop for the microphone insertion ensuring perfect position of the microphone every time.

It is an advantage of the holding device that it comprises the boundary surface which provides a boundary surface behind the microphone, e.g. microphone capsule, to create a specific acoustic frequency boost.

It is an advantage of the holding device that it comprises the supporting portion which ensures enough air volume around the microphone to provide optimal wind protection efficiency.

Microphones require typically wind protection in outdoor applications to ensure good sound quality in adverse weather conditions. However, there is typically a trade-off between sound quality and the amount of wind protection one can achieve, particularly at high frequencies. The materials used for achieving great wind performance create more acoustic attenuation at high frequencies. This means that the overall frequency response of a microphone equipped with wind shield or wind protection has a poorer acoustic response at high frequencies, with significant changes in frequency response above 10 kHz.

The present invention is a technological solution where the negative impact of the wind protection material on the acoustic performance of the microphone is counter-balanced by the holding device, which is a wind protection holder. The holding device is designed to create a pressure zone around the microphone that compensates for the losses introduced at high frequencies by the wind protection material. The microphone may be flush mounted to the holding device, creating a boundary surface around the microphone, whose geometry and dimensions create a pressure increase around the microphone due to acoustic scattering. This is a frequency dependent phenomenon. At low frequencies, the wavelength of the incident sound is much larger than the dimensions of the holding device, which makes the holding device acoustically transparent. At mid frequencies, when the wavelength of the incident waves starts being comparable to the dimensions of the holding device, a pressure build up will rise in front of the microphone. This effect becomes more and more prominent with increasing frequency until the wavelength of the incident waves will be significantly smaller than the dimensions of the holding device. At this point the holding device will generate total or partial constructive/destructive interferences with the incident sound strongly depending on the frequency. The geometry may be important when designing the acoustic scattering of the holding device for counterbalancing the acoustic losses introduced by the wind protection material.

The losses introduced by wind protection materials and the existence of acoustic scattering around objects are known to the skilled person, but the advantages of the present invention are that these two concepts are considered together and tuning them so that they counter-balance each other. When comparing the response of the same microphone with three different wind protection solutions, then the holding device of the present invention preserves the original response of the microphone at high frequencies, while the prior art/state of the art wind protection solutions deliver a very poor response above 7-10 kHz.

Moreover, the present invention is further optimized for wind performance with an extra feature in holding device, which is the stopping element which is a microphone stop, or mic-stop. This is a mechanical feature of the holding device that ensures that the microphone may always be placed at the optimal position, that is, within the pressure zone targeted in the frequency range from 2 kHz to 20 kHz and the same distance from the wind protection material that ensures consistent and maximal wind performance.

Therefore, the present invention allows for optimal wind and sound performance in adverse weather conditions, without trade-offs, as if the microphone was used indoors or in favourable weather conditions.

In some embodiments, the boundary surface is for acoustically amplifying a specific frequency range of a sound signal impinging on the microphone.

In some embodiments, the boundary surface is defined by its shape and/or size. The shape may be circular, round, oval, rectangular, square, triangular etc. The boundary surface may have an extension, e.g. a diameter, in a range of about 7 mm to about 17 mm, such as 8 mm to 16 mm, such as 9 mm to 15 mm, such as 10 mm to 14 mm, such as 11 mm to 13 mm, such as 12 mm (millimeter).

In some embodiments, the boundary surface has a substantially circular shape. It is an advantage to have a circular shape of the boundary surface because a circular shape may provide the best size/performance coefficient, and create the most harmonic frequency range amplification.

In some embodiments, the boundary surface has a substantially flat face which is perpendicular to an insertion direction of the microphone.

In some embodiments, the boundary surface is a top surface of the clamping mechanism.

In some embodiments, the boundary surface is dimensioned for acoustically amplifying the specific frequency range of a sound signal by utilizing the fact that the wavelengths of the specific frequency range of a sound signal have specific lengths which are short enough to be reflected by the boundary surface.

In some embodiments, the boundary surface is configured for extending in a plane around the microphone, when the clamping mechanism is fixated on the microphone. The microphone, e.g. the microphone capsule, may be positioned anywhere inside the pressure zone, pressure field. However, for the intended application of the holding device it may be advantageous to locate microphone in the centre of the boundary surface to achieve a symmetrical polar response. If the microphone is located outside the symmetrical centre of the surface, reflections and phase correlations may cause a change of the frequency response depending on the direction of arrival of the sound. Therefore, the microphone may change in sound with its orientation to the sound source. However, the position may be adjusted for other applications.

In some embodiments, the clamping mechanism is configured to be activated by a user, and wherein the clamping mechanism has an open position when the user activates the clamping mechanism to open, and wherein the clamping mechanism has a closed position when the user foregoes activating the clamping mechanism, and wherein, when the clamping mechanism is in the open position, the microphone is configured to be inserted/retracted through the opening, and wherein, when the clamping mechanism is in the closed position, the clamping mechanism is configured for fixating on the microphone.

In some embodiments, the clamping mechanism comprises a first clamping part and a second clamping part, and wherein the first clamping part has a first primary element and a first secondary element, and wherein the second clamping part has a second primary element and a second secondary element, wherein the first primary element is defining the opening together with the second primary element. The first clamping part and the second clamping part may have similar dimensions. The first clamping part and the second clamping part may be, at least partly, mirrored relative to each other. The first clamping part and the second clamping part may have a length in a range of about 27 mm to about 17 mm, such as 26 mm to 18 mm, such as 25 mm to 19 mm, such as 24 mm to 20 mm, such as 23 mm to 21 mm, such as 22 mm, such as 21.1, such as 21.2 mm, such as 21.3 mm, such as 21.4 mm, such as 21.5 mm, such as 21.6 mm, such as 21.7 mm, such as 21.8 mm, such as 21.9 mm (millimeter).

In some embodiments, the first clamping part and the second clamping part are joined together in a pivot point, and wherein the pivot point is arranged in the first primary element and in the second primary element, and wherein the pivot point is arranged close to transition/division between the first/second primary element and the first/second secondary element.

In some embodiments, the size of the opening is adjustable due to different possible positions of the first primary element and the second primary element relative to each other. The different possible positions may be different closed positions of the clamping mechanism. If an inserted microphone has a wide diameter, then the opening may be in a wide position and have a wide diameter. If an inserted microphone has a narrow diameter, then the opening may be in a narrow position and have a narrow diameter. The opening may have a diameter in range of about 1.5 mm to 7.5 mm, such as 2.0 mm to 7.0 mm, such as 2.5 mm to 6.5 mm, such as 3.0 mm to 6.0 mm, such as 3.5 mm to 5.5 mm, such as 4.0 mm to 5.0 mm, such as 4.5 mm.

In some embodiments, the first primary element and the second primary element are both shaped substantially as a half circle, and wherein the first primary element and the second primary element are configured to partly overlap, and when the first primary element and the second primary element partly overlap they are configured to form a full circle. The first primary element and the second primary element may partly overlap in all positions of the clamping mechanism, i.e. both in the closed position of the clamping mechanism and in the open position of the clamping mechanism. Thus, there may be no gap between the first primary element and the second primary element in any position. The overlap of the first primary element and the second primary element may be bigger when the clamping mechanism is in the closed position compared to the open position. It is an advantage that the first primary element and the second primary element are configured to partly overlap because this may improve the acoustic attenuation of the specific frequencies.

In some embodiments, the first secondary element of the first clamping part and the second secondary element of the second clamping part are both shaped as elongated elements extending from the first primary element and the second primary element, respectively, and wherein the first secondary element and the second secondary element are configured to be pressed towards each other/pushed together by the user when the user is activating the clamping mechanism to open. When the first secondary element and the second secondary element are pressed together by the user for opening the clamping mechanism for insertion of the microphone, the distance between the first secondary element and the second secondary element may be 0 mm, or close to 0 mm. When the first secondary element and the second secondary element are not pressed together but are in the closed position of the clamping mechanism, the distance between the end points of the first secondary element and the second secondary element, i.e. the ends of the first secondary element and the second secondary element being in the opposite end relative to the transition/division between the primary element and the secondary element, may be in a range of about 12 mm to 18 mm, such as 13 mm to 17 mm, such as 14 mm to 16 mm, such as 15 mm, such as 15.3 mm.

In some embodiments, the first primary element and the second primary element both comprise a recess/cut-out, and wherein the opening is defined by the recesses/cut-outs.

In some embodiments, the stopping element comprises a first stopping part connected to the first clamping part, and a second stopping part connected to the second clamping part. The first stopping part may be connected to the boundary surface on the first clamping part, and the second stopping part may be connected to the boundary surface on the second clamping part.

In some embodiments, the stopping element comprises an L-shaped element, which extends substantially perpendicular from the boundary surface and bends over the opening. The L-shaped element may be the first stopping part and the second stopping part. The L-shaped element may have a first axial part extending axially from the boundary surface, and a second radial part connected to the axial part and being perpendicular to the axial part, and the second radial part may extend over the opening.

In some embodiments, the supporting portion to support the wind shield material is shaped as an arch, and wherein the supporting portion extends from the boundary surface, and wherein the supporting portions extends substantially perpendicular from the boundary surface. The supporting portion may comprise one or more arches. Each arch may be connected to the boundary surface at two positions. The diameter of the supporting portion, such as the diameter of the arch, may be in a range of about 9.5 mm to 15.5 mm, such as 10.0 mm to 15.0 mm, such as 10.5 mm to 14.5 mm, such as 11.0 mm to 14.0 mm, such as 11.5 m to 13.5 mm, such as 12.0 mm to 13.0 mm, such as 12.5 mm. The supporting portion may comprise a first arch and a second arch. The first arch may be connected to the boundary surface at the first clamping part, such as connected at the first primary element. The second arch may be connected to the boundary surface at the second clamping part, such as connected at the second primary element. The height of the holding device from the bottom of the clamping parts to the top of the supporting portion may be in a range of about 10.5 mm to 16.5 mm, such as 11.0 mm to 16.0 mm, such as 11.5 mm to 15.5 mm, such as 12.0 mm to 15.0 mm, such as 12.5 mm to 14.5 mm, such as 13.0 mm to 14.00 mm, such as 13.5 mm, such as 13.8 mm. It is an advantage to have the supporting portion to support the wind shield material because this may create a big air volume inside the space enclosed by the boundary surface and the wind shield material.

In some embodiments, the wind shield material comprises a faux fur material or a fabric.

In some embodiments, the microphone is a lavalier microphone or a microphone for a headset.

The present invention relates to different aspects including the holding device described above and in the following, and corresponding device parts, each yielding one or more of the benefits and advantages described in connection with the first mentioned aspect, and each having one or more embodiments corresponding to the embodiments described in connection with the first mentioned aspect and/or disclosed in the appended claims.

### BRIEF DESCRIPTION OF THE DRAWINGS

The above and other features and advantages will become readily apparent to those skilled in the art by the following detailed description of exemplary embodiments thereof with reference to the attached drawings, in which:

FIG. 1 schematically illustrates an exemplary holding device 2, in a perspective view, for a wind shield and a microphone.

FIG. 2 schematically illustrates an exemplary holding device 2, in a perspective view, with a microphone inserted.

FIG. 3 schematically illustrates an exemplary holding device 2, in a perspective view.

FIGS. 4a and 4b schematically illustrate an exemplary holding device 2, in a top view and bottom view, respectively.

FIGS. 5a, 5b and 5c schematically illustrate an exemplary holding device 2, in different side views.

FIGS. 6a and 6b schematically illustrate an exemplary holding device 2, with a wind shield 4 attached.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

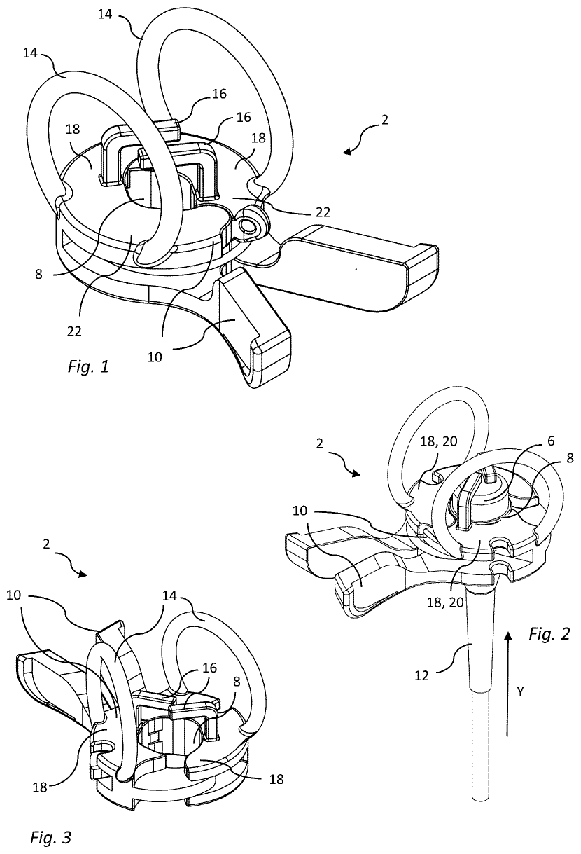

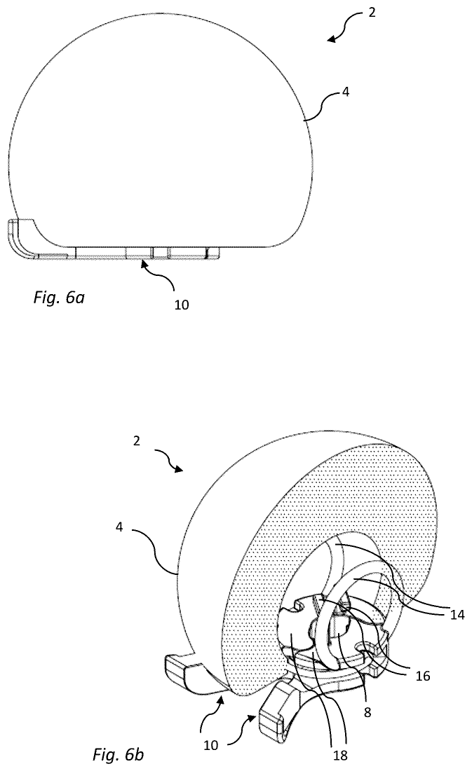

FIG. 1 schematically illustrates an exemplary holding device 2 for a wind shield (not shown) and a microphone (not shown). FIGS. 6a and 6b show an example where the wind shield 4 is at the holding device 2. FIG. 2 shows an example where the microphone 6 is in the holding device 2.

The holding device 2 comprises an opening 8 for insertion and/or retraction of the microphone in the holding device 2. The holding device 2 comprises a clamping mechanism 10 for fixating on the microphone. The holding device 2 comprises a supporting portion 14 for supporting a material of the wind shield. The holding device 2 comprises a stopping element 16 for arranging the microphone in a desired position in the holding device 2. The holding device 2 comprises a boundary surface 18, which may be for acoustically amplifying a specific frequency range of a sound signal impinging on the microphone.

The boundary surface 18 is defined by its shape and/or size. The boundary surface 18 has a substantially circular shape. The boundary surface 18 is a top surface 22 of the clamping mechanism 10.

FIG. 2 schematically illustrates an exemplary holding device 2 where the microphone 6 is in the holding device 2. The microphone 6 is inserted through the opening 8 in the holding device 2. The microphone 6 is inserted in the insertion direction Y. The boundary surface 18 has a substantially flat face 20 which is perpendicular to the insertion direction Y of the microphone. The boundary surface 18 is configured for extending in a plane around the microphone 6, when the clamping mechanism 10 is fixated on the microphone 6. The microphone 6 comprises a housing/cord 12 which extends from the microphone through the opening 8.

FIG. 3 schematically illustrates an exemplary holding device 2 for a wind shield (not shown) and a microphone (not shown). The holding device 2 comprises an opening 8 for insertion and/or retraction of the microphone in the holding device 2. The holding device 2 comprises a clamping mechanism 10 for fixating on the microphone. The holding device 2 comprises a supporting portion 14 for supporting a material of the wind shield. The holding device 2 comprises a stopping element 16 for arranging the microphone in a desired position in the holding device 2. The holding device 2 comprises a boundary surface 18, which may be for acoustically amplifying a specific frequency range of a sound signal impinging on the microphone.

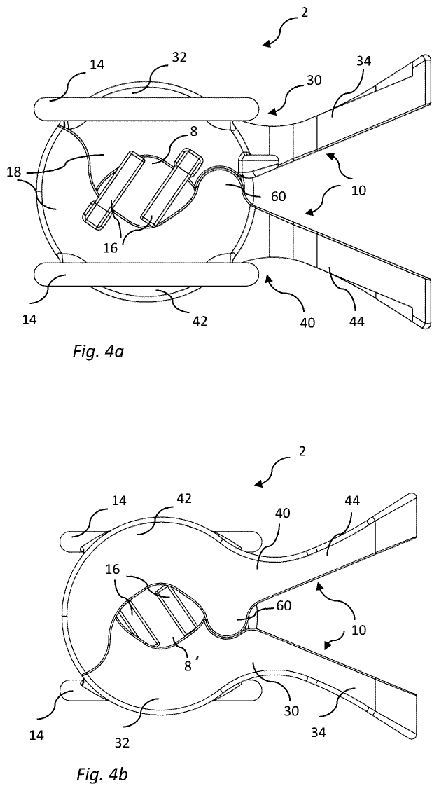

The clamping mechanism 10 is configured to be activated by a user. The clamping mechanism 10 has an open position, which is shown in FIG. 3, when the user activates the clamping mechanism to open. The clamping mechanism 10 also has a closed position when the user foregoes activating the clamping mechanism. An example of a closed position is seen in FIG. 1, FIG. 2 and in FIGS. 4a and 4b. When the clamping mechanism 10 is in the open position as seen in FIG. 3, the microphone is configured to be inserted/retracted through the opening 8. When the clamping mechanism 10 is in the closed position, the clamping mechanism 10 is configured for fixating on the microphone as seen in e.g. FIG. 2.

FIGS. 4a and 4b schematically illustrates an exemplary holding device 2 for a wind shield (not shown) and a microphone (not shown). The holding device 2 comprises an opening 8 for insertion and/or retraction of the microphone in the holding device 2. The holding device 2 comprises a clamping mechanism 10 for fixating on the microphone. The holding device 2 comprises a supporting portion 14 for supporting a material of the wind shield. The holding device 2 comprises a stopping element 16 for arranging the microphone in a desired position in the holding device 2. The holding device 2 comprises a boundary surface 18, which may be for acoustically amplifying a specific frequency range of a sound signal impinging on the microphone. In FIG. 4a the holding device 2 is seen from above, and the boundary surface 18 is visible. In FIG. 4b the holding device 2 is seen from below, and the boundary surface is not visible.

The clamping mechanism 10 comprises a first clamping part 30 and a second clamping part 40. The first clamping part 30 has a first primary element 32 and a first secondary element 34. The second clamping part 40 has a second primary element 42 and a second secondary element 44. The first primary element 32 is defining the opening 8 together with the second primary element 42.

The first clamping part 30 and the second clamping part 40 are joined together in a pivot point 60. The pivot point 60 is arranged in the first primary element 32 and in the second primary element 42. The pivot point 60 is arranged close to transition/division between the first primary element 32 and the first secondary element 34 of the first clamping part 30. Similarly, the pivot point 60 is arranged close to transition/division between the second primary element 42 and the second secondary element 44 of the second clamping 40.

The size of the opening 8 is adjustable due to different possible positions of the first primary element 32 and the second primary element 42 relative to each other. Different sizes of the opening 8 can be seen e.g. in FIG. 1, FIG. 2, FIG. 3 and FIGS. 4a and 4b. In FIG. 1 and FIGS. 4a and 4b, the clamping mechanism 10 may be in an entirely closed position, and here the opening 8 is as small in size as possible. In FIG. 3, the clamping mechanism 10 may be in an entirely open position, and here the opening 8 may be as big as possible. In FIG. 2, the clamping mechanism 10 may be in an intermediate position where the clamping mechanism 10 is fixating on the microphone 6, and here the opening 8 may be in intermediate size.

In FIGS. 4a and 4b, it can be seen that the first primary element 32 and the second primary element 42 are both shaped substantially as a half circle. The first primary element 32 and the second primary element 42 are configured to partly overlap. When the first primary element 32 and the second primary element 42 partly overlap they are configured to form a full circle. The first primary element 32 and the second primary element 42 may partly overlap in all positions of the clamping mechanism 10, i.e. both in the closed position of the clamping mechanism 10 e.g. as seen in FIG. 1 and FIGS. 4a and 4b, and in an open position of the clamping mechanism 10, e.g. as seen in FIG. 2 and FIG. 3. Thus, there may be no gap between the first primary element 32 and the second primary element 42 in any position. The overlap of the first primary element 32 and the second primary element 42 may be bigger when the clamping mechanism 10 is in the closed position as seen in e.g. FIG. 1 and FIGS. 4a and 4b, compared to an open position of the clamping mechanism 10 as seen in e.g. FIG. 2 and FIG. 3.

The first secondary element 34 of the first clamping part 30 and the second secondary element 44 of the second clamping part 40 are both shaped as elongated elements extending from the first primary element 32 and the second primary element 42, respectively. The first secondary element 34 and the second secondary element 44 are configured to be pressed towards each other/pushed together by the user, when the user is activating the clamping mechanism to open, see e.g. FIG. 3.

The first primary element 32 and the second primary element 42 both comprise a recess/cut-out, and the opening 8 is defined by the recesses/cut-outs.

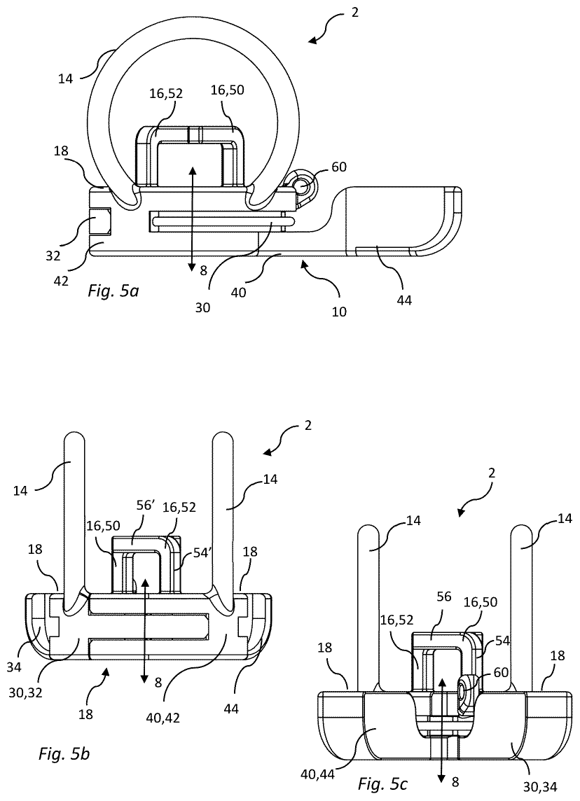

FIGS. 5a, 5b and 5c schematically illustrate an exemplary holding device 2 for a wind shield (not shown) and a microphone (not shown). The holding device 2 comprises an opening 8 for insertion and/or retraction of the microphone in the holding device 2. The holding device 2 comprises a clamping mechanism 10 for fixating on the microphone. The holding device 2 comprises a supporting portion 14 for supporting a material of the wind shield. The holding device 2 comprises a stopping element 16 for arranging the microphone in a desired position in the holding device 2. The holding device 2 comprises a boundary surface 18, which may be for acoustically amplifying a specific frequency range of a sound signal impinging on the microphone.

In FIG. 5a the holding device 2 is seen in a longitudinal side view. In FIG. 5b the holding device 2 is seen in a transversal side view from the end where the supporting portion 14 is arranged. In FIG. 5c the holding device 2 is seen in a transversal side view from the other end where the secondary elements 34, 44 of the clamping parts 30, 40 are arranged.

The clamping mechanism 10 comprises a first clamping part 30 and a second clamping part 40. The first clamping part 30 has a first primary element 32 and a first secondary element 34. The second clamping part 40 has a second primary element 42 and a second secondary element 44. The first clamping part 30 and the second clamping part 40 are joined together in a pivot point 60. The pivot point 60 is arranged in the first primary element 32 and in the second primary element 42.

The stopping element 16 comprises a first stopping part 50 connected to the first clamping part 30. The stopping element 16 comprises a second stopping part 52 connected to the second clamping part 40. The first stopping part 50 and the second stopping part 52 are connected at the boundary surface 18.

The stopping element 16, such as the first stopping part 50 and the second stopping part 52, comprises an L-shaped element, which extends substantially perpendicular from the boundary surface 18 and bends over the opening 8. The stopping element 16, such as the L-shaped element, has a first axial part extending axially from the boundary surface 18, and a second radial part connected to the axial part and being perpendicular to the axial part, and the second radial part is extending over the opening 8. The first stopping element 50 has a first axial part 54 extending axially from the boundary surface 18, and a second radial part 56 connected to the axial part 54 and being perpendicular to the axial part 54, and the second radial part 56 is extending over the opening 8. The second stopping element 52 has a first axial part 54′ extending axially from the boundary surface 18, and a second radial part 56′ connected to the axial part 54′ and being perpendicular to the axial part 54′, and the second radial part 56′ is extending over the opening 8.

FIG. 6 schematically illustrates an exemplary holding device 2 for a wind shield 4 and a microphone (not shown). FIGS. 6a and 6b show an example where the wind shield 4 is at the holding device 2. The holding device 2 comprises an opening 8 for insertion and/or retraction of the microphone in the holding device 2. The holding device 2 comprises a clamping mechanism 10 for fixating on the microphone. The holding device 2 comprises a supporting portion 14 for supporting a material of the wind shield. The holding device 2 comprises a stopping element 16 for arranging the microphone in a desired position in the holding device 2. The holding device 2 comprises a boundary surface 18, which may be for acoustically amplifying a specific frequency range of a sound signal impinging on the microphone.

FIG. 6a shows the holding device 2 with the wind shield 4 in a longitudinal side view. The wind shield 4 covers most of the holding device 2, and only part of the bottom part of the clamping mechanism 10 is visible.

FIG. 6b shows the wind shield 4 in a section view, such that it can be seen that the wind shield 4 is hollow inside, and that the parts of the holding device 2 is enclosed by the hollow part of the wind shield 4.

The supporting portion 14 to support the wind shield material 4 is shaped as an arch. The supporting portion 14 comprises two arches. The supporting portion 14 extends from the boundary surface 18, and the supporting portion 14 extends substantially perpendicular from the boundary surface 18.

The wind shield material may comprise a faux fur material, a fabric etc.

Although particular features have been shown and described, it will be understood that they are not intended to limit the claimed invention, and it will be made obvious to those skilled in the art that various changes and modifications may be made without departing from the scope of the claimed invention. The specification and drawings are, accordingly to be regarded in an illustrative rather than restrictive sense. The claimed invention is intended to cover all alternatives, modifications and equivalents.

### Items

1a. A holding device (2) for a wind shield (4) and a microphone (6), the holding device (2) comprising:
an opening (8) for insertion and/or retraction of the microphone (6) in the holding device;
a clamping mechanism (10) for fixating on the microphone (6);
a supporting portion (14) for supporting a material of the wind shield (4);
a stopping element (16) for arranging the microphone (6) in a desired position in the holding device (2); and
a boundary surface (18).

1b. A holding device (2) for a wind shield (4) and a microphone (6), the holding device (2) comprising:
an opening (8) for insertion and/or retraction of the microphone (6) in the holding device;
a clamping mechanism (10) for fixating on the microphone (6);
a supporting portion (14) for supporting a material of the wind shield (4);
a stopping element (16) for arranging the microphone (6) in a desired position in the holding device (2); and
a boundary surface (18) for acoustically amplifying a specific frequency range of a sound signal impinging on the microphone (6).

2a. The holding device according to any of the preceding items, wherein the boundary surface is for acoustically amplifying a specific frequency range of a sound signal impinging on the microphone (6).

2b. The holding device according to any of the preceding items, wherein the boundary surface is defined by its shape and/or size.

3. The holding device according to any of the preceding items, wherein the boundary surface has a substantially circular shape.

4. The holding device according to any of the preceding items, wherein the boundary surface has a substantially flat face (20) which is perpendicular to an insertion direction (Y) of the microphone.

5. The holding device according to any of the preceding items, wherein the boundary surface is a top surface (22) of the clamping mechanism.

6. The holding device according to any of the preceding items, wherein the boundary surface is dimensioned for acoustically amplifying the specific frequency range of a sound signal by utilizing the fact that the wavelengths of the specific frequency range of a sound signal have specific lengths which are short enough to be reflected by the boundary surface.

7. The holding device according to any of the preceding items, wherein the boundary surface is configured for extending in a plane around the microphone, when the clamping mechanism is fixated on the microphone.

8. The holding device according to any of the preceding items, wherein the clamping mechanism is configured to be activated by a user, and wherein the clamping mechanism has an open position when the user activates the clamping mechanism to open, and wherein the clamping mechanism has a closed position when the user foregoes activating the clamping mechanism, and wherein, when the clamping mechanism is in the open position, the microphone is configured to be inserted/retracted through the opening, and wherein, when the clamping mechanism is in the closed position, the clamping mechanism is configured for fixating on the microphone.

9. The holding device according to any of the preceding items, wherein the clamping mechanism comprises a first clamping part (30) and a second clamping part (40), and wherein the first clamping part (30) has a first primary element (32) and a first secondary element (34), and wherein the second clamping part (40) has a second primary element (42) and a second secondary element (44), wherein the first primary element (32) is defining the opening (8) together with the second primary element (42).

10. The holding device according to any of the preceding items, wherein the size of the opening (8) is adjustable due to different possible positions of the first primary element (32) and the second primary element (42) relative to each other.

11. The holding device according to any of the preceding items, wherein the first primary element and the second primary element are both shaped substantially as a half circle, and wherein the first primary element and the second primary element are configured to partly overlap, and when the first primary element and the second primary element partly overlap they are configured to form a full circle.

12. The holding device according to any of the preceding items, wherein the first secondary element (34) of the first clamping part (30) and the second secondary element (44) of the second clamping part (40) are both shaped as elongated elements extending from the first primary element (32) and the second primary element (42), respectively, and wherein the first secondary element (34) and the second secondary element (44) are configured to be pressed towards each other/pushed together by the user when the user is activating the clamping mechanism to open.

13. The holding device according to any of the preceding items, wherein the first primary element (32) and the second primary element (42) both comprise a recess/cut-out, and wherein the opening (8) is defined by the recesses/cut-outs.

14. The holding device according to any of the preceding items, wherein the stopping element (16) comprises a first stopping part (50) connected to the first clamping part (30), and a second stopping part (52) connected to the second clamping part (40).

15. The holding device according to any of the preceding items, wherein the stopping element (16) comprises an L-shaped element, which extends substantially perpendicular from the boundary surface and bends over the opening.

16. The holding device according to any of the preceding items, wherein the supporting portion to support the wind shield material is shaped as an arch, and wherein the supporting portion extends from the boundary surface, and wherein the supporting portions extends substantially perpendicular from the boundary surface.

17. The holding device according to any of the preceding items, wherein the wind shield material comprises a faux fur material or fabric.

18. The holding device according to any of the preceding items, wherein the microphone is a lavalier microphone or a microphone for a headset.

### LIST OF REFERENCES

2 holding device
4 wind shield
6 microphone
8 opening
10 clamping mechanism
12 housing/cord of microphone
14 supporting portion
16 stopping element
18 boundary surface
20 flat face of boundary surface
22 top surface of the clamping mechanism
30 first clamping part
32 first primary element
34 first secondary element
40 second clamping part
42 second primary element
44 second secondary element
50 first stopping part
52 second stopping part
54, 54′ first axial part
56, 56′ second radial part
60 pivot point
Y insertion direction of microphone

1. A holding device for a wind shield and a microphone, the holding device comprising:
an opening for insertion and/or retraction of the microphone in the holding device;
a clamping mechanism for fixating on the microphone;
a supporting portion for supporting a material of the wind shield;
a stopping element for arranging the microphone in a desired position in the holding device; and
a boundary surface.

2. The holding device according to claim 1, wherein the boundary surface is configured for acoustically amplifying a specific frequency range of a sound signal impinging on the microphone.

3. The holding device according to claim 1, wherein the boundary surface is defined by its shape and/or size, and/or wherein the boundary surface has a substantially circular shape.

4. The holding device according to claim 1, wherein the boundary surface has a substantially flat face which is perpendicular to an insertion direction (Y) of the microphone.

5. The holding device according to claim 1, wherein the boundary surface is a top surface of the clamping mechanism.

6. The holding device according to claim 1, wherein the boundary surface is dimensioned for acoustically amplifying the specific frequency range of a sound signal by utilizing the fact that the wavelengths of the specific frequency range of a sound signal have specific lengths, which are short enough to be reflected by the boundary surface.

7. The holding device according to claim 1, wherein the boundary surface is configured for extending in a plane around the microphone, when the clamping mechanism is fixated on the microphone.

8. The holding device according to claim 1, wherein the clamping mechanism is configured to be activated by a user, and wherein the clamping mechanism has an open position when the user activates the clamping mechanism to open, and wherein the clamping mechanism has a closed position when the user foregoes activating the clamping mechanism, and wherein, when the clamping mechanism is in the open position, the microphone is configured to be inserted/retracted through the opening, and wherein, when the clamping mechanism is in the closed position, the clamping mechanism is configured for fixating on the microphone.

9. The holding device according to claim 1, wherein the clamping mechanism comprises a first clamping part and a second clamping part, and wherein the first clamping part has a first primary element and a first secondary element, and wherein the second clamping part has a second primary element and a second secondary element, wherein the first primary element is defining the opening together with the second primary element.

10. The holding device according to claim 1, wherein the size of the opening is adjustable due to different possible positions of the first primary element and the second primary element relative to each other.

11. The holding device according to claim 1, wherein the first primary element and the second primary element are both shaped substantially as a half circle, and wherein the first primary element and the second primary element are configured to partly overlap, and when the first primary element and the second primary element partly overlap they are configured to form a full circle.

12. The holding device according to claim 1, wherein the first secondary element of the first clamping part and the second secondary element of the second clamping part are both shaped as elongated elements extending from the first primary element and the second primary element, respectively, and wherein the first secondary element and the second secondary element are configured to be pressed towards each other/pushed together by the user when the user is activating the clamping mechanism to open.

13. The holding device according to claim 1, wherein the first primary element and the second primary element both comprise a recess/cut-out, and wherein the opening is defined by the recesses/cut-outs.

14. The holding device according to claim 1, wherein the stopping element comprises a first stopping part connected to the first clamping part, and a second stopping part connected to the second clamping part.

15. The holding device according to claim 1, wherein the stopping element comprises an L-shaped element, which extends substantially perpendicular from the boundary surface and bends over the opening.
